(19) United States
(12) Patent Application Publication
(10) Pub. No.: US 2013/0030894 A1
(43) Pub. Date: Jan. 31, 2013

(54) SYSTEM FOR CUSTOMER REFERRAL PROGRAM

(71) Applicant: Lance Bloom, Nashville, TN (US)

(72) Inventor: Lance Bloom, Nashville, TN (US)

(21) Appl. No.: 13/555,143

(22) Filed: Jul. 21, 2012

Related U.S. Application Data
(60) Provisional application No. 61/512,669, filed on Jul. 28, 2011.

(51) Int. Cl. G06Q 30/02

(52) U.S. Cl. 705/14.16

(57) ABSTRACT

A system and related methods for a proprietary system, or a business or merchant, to track purchases by customers, and associate those purchases with one or more other customers who referred, directly or indirectly, the purchasing customer to that business or merchant. The purchasing customer also may be rewarded for purchases made by other customers that the purchasing customer has referred to the business or merchant, directly or indirectly, through social media sites or networks.

This application claims benefit of and priority to U.S. Provisional Application No. 61/512,669, filed Jul. 28, 2011, by Lance Bloom, and is entitled to that filing date for priority. The specification, figures and complete disclosure of U.S. Provisional Application No. 61/512,669 are incorporated herein by specific reference for all purposes.

### FIELD OF INVENTION

This invention relates to a system and method for rewarding customers for business referrals through social networking.

### SUMMARY OF INVENTION

In various exemplary embodiments, the present invention comprises a system and related methods for a business or merchant to track purchases by customers, and associate those purchases with one or more other customers who referred, directly or indirectly, the purchasing customer to that business or merchant. The purchasing customer also may be rewarded for purchases made by other customers that the purchasing customer has referred to the business or merchant, directly or indirectly. The system and method may be integrated into its own proprietary system, or may be integrated with the point-of-sale system of a business.

In one exemplary embodiment, the merchant or business generates a 2-D barcode. The barcode may be generated through a cell phone application, POS system, credit card terminal, Internet, computer software, or other means of generation. The 2-D barcode is encoded with information such as, but not limited to, the following: Merchant Account Number; Purchase Price; Order Number; Item Numbers; and Total Sale.

The 2-D barcode is displayed or printed on a smartphone, POS system, receipt, computing device screen, or the like. The 2-D barcode may read by an appropriate device, such as a computer or smartphone application. The information on the 2-D barcode is decoded by the application and the information is populated on an order form. The user selects his method of payment, and confirms the transaction. The application may contact a third party for authorization, if applicable. The third party authorizes or denies the transaction.

When the transaction is complete, the application server links the user's account number with the merchant's account number. For that payment, and every payment made between the user and merchant in the future, the user will receive points from the merchant redeemable by the user for a discount on a purchase from said merchant.

A user also may receive points from referrals of other users to the merchant. Thus, for example, User B is referred to said merchant by User A, and User B makes a purchase and indicates to said merchant that user A is his referrer. User A thereupon receives points redeemable at said merchant, as described above. Once User B indicates to merchant that User A is his referrer, User A and B then are linked with each other in the merchant's system. Thereafter, whenever User B makes a purchase from said merchant, User A gets referral points.

Indirect referrals also may result in points for User A. For example, if User B subsequently refers User C to said merchant, then every purchase from said merchant by User C will generate referral points for both User B and User A. And any user referred by User C will generate points for User A, B and C. The points generated for each may be the same, or may differ, depending on the number of levels between the purchaser and the referrers.

In another exemplary embodiment, users also will have the opportunity to share his or her purchase with others through social media or otherwise. For example, a user can send out an update to his or her social media sites on the Internet with an update including a description of the purchase and his or her happiness with said purchase. In that update will be a link. If a viewer is not a user of the product, the link will take him to the sign-up page for the application and service. The link also may contain an embedded token that links the sign-up page with the user who sent out the social update. If there is a successful new sign up, that user who sent out the social update will get a certain amount of points that can be redeemed for discounts at participating merchants.

### DESCRIPTION OF THE DRAWINGS

FIG. 1 shows a view of a system in accordance with an embodiment of the present invention.

### DETAILED DESCRIPTION OF EXEMPLARY EMBODIMENTS

In various exemplary embodiments, the present invention comprises a system and related methods for a business or merchant to track purchases by customers, and associate those purchases with one or more other customers who referred, directly or indirectly, the purchasing customer to that business or merchant. The purchasing customer also may be rewarded for purchases made by other customers that the purchasing customer has referred to the business or merchant, directly or indirectly.

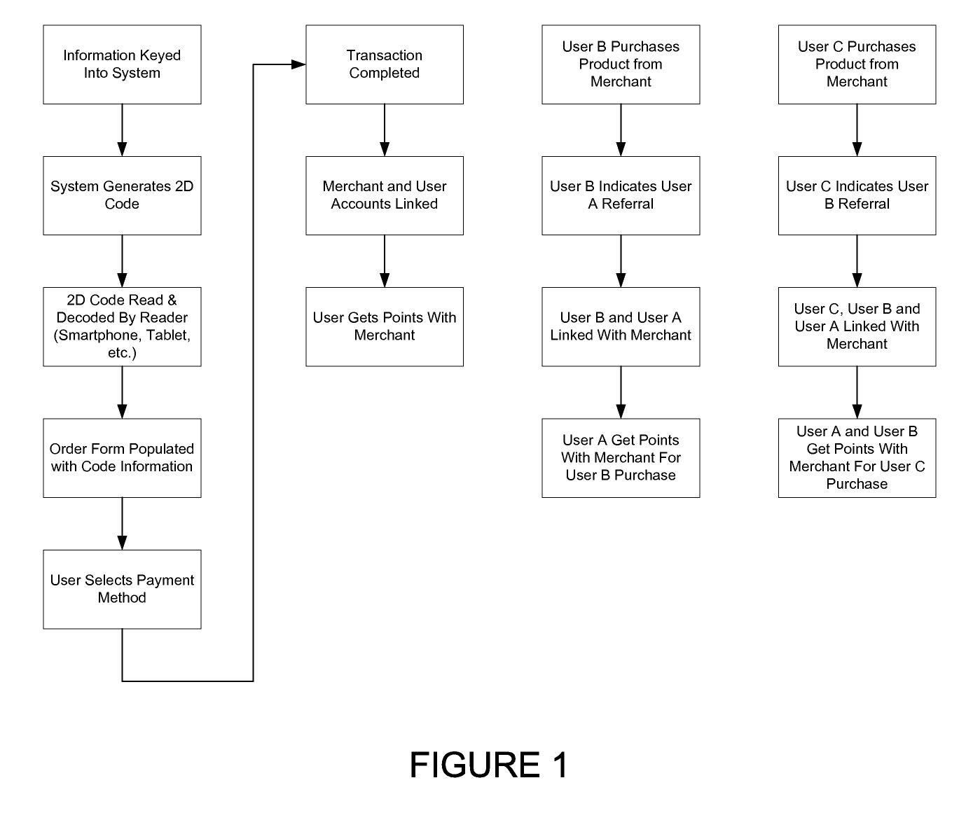

In one exemplary embodiment, as seen in FIG. 1, the merchant or business generates a 2-D barcode. The barcode may be generated through a cell phone application, POS system, credit card terminal, Internet, computer software, or other means of generation. The 2-D barcode is encoded with information such as, but not limited to, the following: Merchant Account Number; Purchase Price; Order Number; Item Numbers; and Total Sale.

The 2-D barcode is displayed or printed on a smartphone, POS system, receipt, computing device screen, or the like. The 2-D barcode may read by an appropriate device, such as a computer or smartphone application. The information on the 2-D barcode is decoded by the application and the information is populated on an order form. The user selects his method of payment, and confirms the transaction. The application may contact a third party for authorization, if applicable. The third party authorizes or denies the transaction.

When the transaction is complete, the application server links the user's account number with the merchant's account number. For that payment, and every payment made between the user and merchant in the future, the user will receive points from the merchant redeemable by the user for a discount on a purchase from said merchant.

A user also may receive points from referrals of other users to the merchant. Thus, for example, User B is referred to said merchant by User A, and User B makes a purchase and indicates to said merchant that user A is his referrer. User A thereupon receives points redeemable at said merchant, as described above. Once User B indicates to merchant that User A is his referrer, User A and B then are linked with each other in the merchant's system. Thereafter, whenever User B makes a purchase from said merchant, User A gets referral points.

Indirect referrals also may result in points for User A. For example, if User B subsequently refers User C to said merchant, then every purchase from said merchant by User C will generate referral points for both User B and User A. And any user referred by User C will generate points for User A, B and C. The points generated for each may be the same, or may differ, depending on the number of levels between the purchaser and the referrers.

In another exemplary embodiment, users also will have the opportunity to share his or her purchase with others through social media or otherwise. For example, a user can send out an update to his or her social media sites on the Internet with an update including a description of the purchase and his or her happiness with said purchase. In that update will be a link. If a viewer is not a user of the product, the link will take him to the sign-up page for the application and service. The link also may contain an embedded token that links the sign-up page with the user who sent out the social update. If there is a successful new sign up, that user who sent out the social update will get a certain amount of points that can be redeemed for discounts at participating merchants.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system, comprising:
a processor or microprocessor coupled to a memory, wherein the processor or microprocessor is programmed to perform the steps of:
receiving information contained in a barcode presented by a first customer on a smartphone or personal computing device in conjunction with a transaction between the first customer and a vendor, said information further including information about the transaction;
providing points to an account for the first customer based upon the information received;
providing, at the direction of the first customer, information about the first customer transaction through one or more social media sites or networks;
receiving information about a second customer transaction with a vendor, the second customer engaging in the second customer transaction as a result of the information about the first customer transaction provided through the one or more social media sites or networks; and
providing points to the account for the first customer based upon the transaction information of the second customer transaction.

2. The system of claim 1, further wherein the information about the customer transaction provided through one or more social media sites or networks includes a link to the system for the second customer to open an account with the system, the link comprising an embedded token that identifies the first customer or first customer account.

3. The system of claim 2, further comprising the step of providing a barcode to the second customer after the second customer opens an account.

4. The system of claim 3, further wherein the information received about the second customer transaction includes information provided in the second customer barcode.

5. The system of claim 4, further comprising the steps of:
providing, at the direction of the second customer, information about the second customer transaction through one or more social media sites or networks, said information comprising a link to the system for a third customer to open an account with the system, the link comprising an embedded token that identifies the second customer or second customer account, and the first customer or first customer account;
receiving information about a third customer transaction with a vendor, the third customer engaging in the third customer transaction as a result of the information about the second customer transaction provided through the one or more social media sites or networks; and
providing points to the account for the first customer and the account of the second customer based upon the transaction information of the third customer transaction.
